(19) United States
(12) Patent Application Publication
(10) Pub. No.: US 2005/0184770 A1
(43) Pub. Date: Aug. 25, 2005

(54) Internal circuit protection device

(75) Inventors: Young Chul Sohn, Seoul (KR); Ja Seung Gou, Gyeonggi-do (KR)

Correspondence Address: HELLER EHRMAN WHITE & MCAULIFFE LLP, 1717 RHODE ISLAND AVE, NW, WASHINGTON, DC, 20036-3001, US

(73) Assignee: Hynix Semiconductor Inc., Gyeonggi-do (KR)

(21) Appl. No.: 10/879,027

(22) Filed: Jun. 30, 2004

(30) Foreign Application Priority Data
Feb. 19, 2004 (KR) 2004-0011042

(51) Int. Cl. H05B 41/16

(52) U.S. Cl. 327/143

(57) ABSTRACT

The present invention provides an internal circuit protection device. The internal circuit protection device detects an abnormal input voltage when the input voltage exceeds a predetermined value, generates an output signal maintaining a high level just in the operating region of a chip by generating a power up signal having an opposite condition to a normal power up signal, and changes the power up signal according to the change of supply voltage by using this output signal, thereby protecting an internal circuit of DRAM chip.

### BACKGROUND OF THE INVENTION

1. Field of the Invention

The present invention relates to an internal circuit protection device. More specifically, the present invention provides a technology of protecting an internal circuit when abnormally high input power is inputted to a DRAM circuit.

2. Description of the Prior Art

Recently, a transistor operating in a low voltage is increasingly used since a supply voltage of DRAM becomes gradually lower. A conventional internal circuit protection device protects a chip from a voltage such as high static electricity by using an Electro Static Discharge(ESD) protection circuit.

However, this device just prevents the static electricity applied externally from being supplied to an internal circuit, and it fails to check whether an input voltage is abnormally inputted around an input terminal to which a power supply is inputted. As such, when an internal or external voltage spike is inputted to the internal circuit simultaneously with the supply voltage, an internal transistor of DRAM is damaged or broken. In this case, the whole chip operates wrongly or its lifetime may reduce.

FIG. 1 is a circuit diagram of a conventional power-up device having no function of internal circuit protection.

The power-up device comprises a voltage dividing unit 1 and a driving unit 2.

The voltage dividing unit 1 has resistors R0 and R1 connected in series between a power voltage terminal VDD and a ground voltage terminal VSS, and divides and outputs the power voltage VDD according to resistance ratio.

The driving unit 2 comprising an inverter IV1 generates a power up signal PU1 having a predetermined gradient according to an output of the voltage dividing unit 1. At this time, the power up signal PU1 rises to the same gradient as the power voltage VDD before supply voltage generated according to the resistance ratio exceeds a threshold voltage of the inverter IV1. When the level of supply voltage exceeds the threshold voltage of the inverter IV1, a voltage level of the power up signal PU1 transits to a logic low level and then it is outputted.

A power up device having the above configuration outputs the power up signal PU1 by generating a voltage for operating the internal circuit at a level of input power voltage VDD.

As mentioned above, the conventional power up circuit performs a role of controlling an initial voltage such as a latch when power is applied to inside of DRAM. However, in case that a voltage level of the input power supply exceeds the preset operating range, a change of the input power supply cannot be exactly detected. Accordingly, the internal circuit cannot be protected from abnormal the input power supply.

### SUMMARY OF THE INVENTION

It is an object of the present invention to detect a voltage exceeding a preset level, to generate a normal power up signal and a power up signal having an opposite condition thereto, to protect an internal circuit of DRAM chip from a change of a power supply by using these signals.

In an embodiment, an internal circuit protection device of the present invention comprises a power up unit for generating a first power up signal when the detected level of power voltage exceeds a first level; a voltage detecting unit for generating a second power up signal when the detected level of power voltage exceeds a second level higher than the first level; and a NOR gate for NORing the first power up signal and second power up signal to generate a control signal for activating the level of power voltage at a predetermined region.

### BRIEF DESCRIPTION OF THE DRAWINGS

Other aspects and advantages of the present invention will become apparent upon reading the following detailed description and upon reference to the drawings in which:

FIG. 1 is a circuit diagram of a conventional power up device.

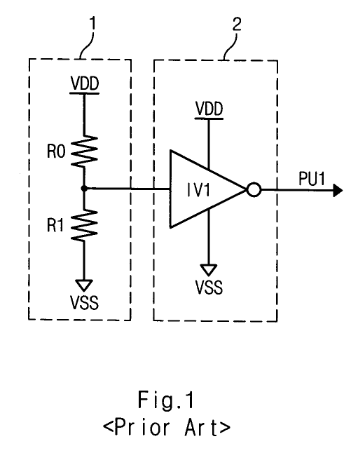

FIG. 2 is a block diagram illustrating an internal circuit protection device according to the present invention.

FIG. 3 is a detailed circuit diagram illustrating a power up unit of FIG. 2.

FIG. 4 is a detailed circuit diagram illustrating a voltage detecting unit of FIG. 2.

FIG. 5 is a waveform chart illustrating output of each signal according to the present invention.

### DETAILED DESCRIPTION OF THE PREFERRED EMBODIMENTS

The present invention will be described in detail with reference to the accompanying drawings.

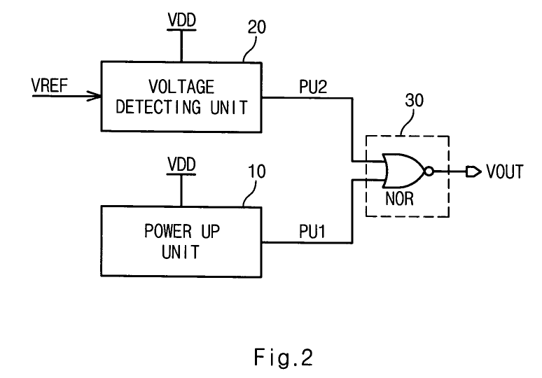

FIG. 2 is a block diagram illustrating an internal circuit protection device of the present invention.

The internal circuit protection device comprises a power up unit 10, a voltage detecting unit 20 and an output unit 30.

The power up unit 10 generates a power up signal PU1 for supplying an initial power up voltage to the inside of DRAM. The voltage detecting unit 20 detects a change of a power voltage VDD by using a reference voltage VREF, and generates a power up signal PU2.

The output unit 30 supplies an output voltage VOUT to an internal circuit by NORing the power up signals PU1 and PU2. A NOR gate NOR is preferred as the output unit 30.

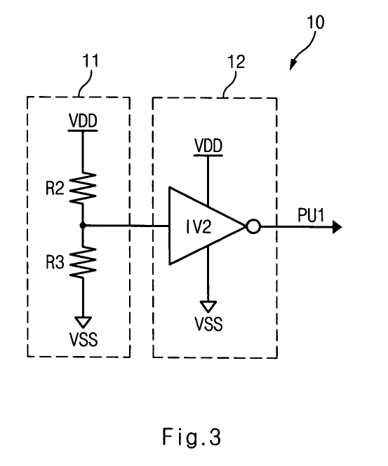

FIG. 3 is a circuit diagram illustrating the power up unit 10 of FIG. 2.

The power up unit 10 comprises a voltage dividing unit 11 and a driving unit 12.

The voltage dividing unit 11 has resistors R2 and R3 connected in series between a power voltage terminal VDD and a ground voltage terminal VSS, and divides the power voltage VDD according to the resistance ratio.

The driving unit 12 comprising an inverter IV1 generates the power up signal PU1 having a predetermined gradient in response to an output of the voltage dividing unit 11. At this time, the power up signal PU1 rises to the same gradient as the power voltage VDD before the level of supply voltage generated according to the resistance ratio exceeds a threshold voltage of the inverter IV2. When a level of supply voltage exceeds the threshold voltage of the inverter IV1, a voltage level of the power up signal PU1 transits to a logic low level and then it is outputted.

The power up unit 10 having the above configuration outputs the power up signal PU1 by generating a voltage for operating an internal circuit at a level of inputted the power voltage VDD.

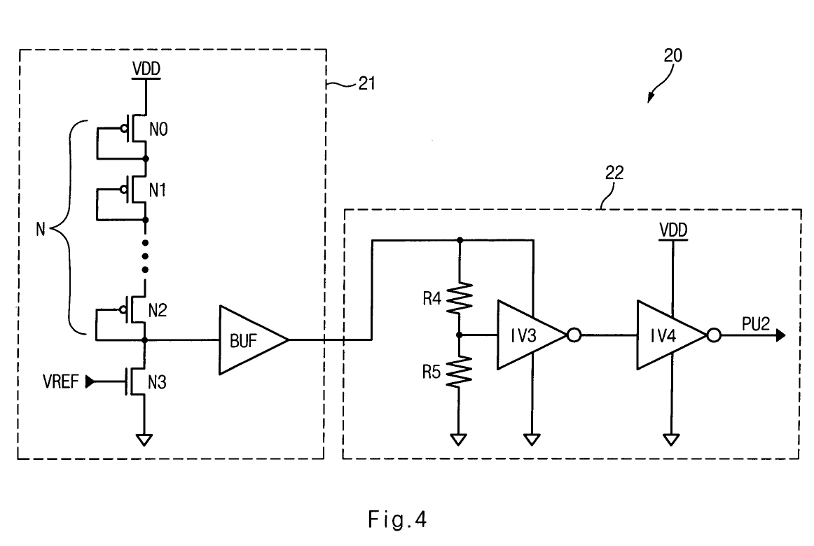

FIG. 4 is a detailed circuit diagram illustrating the voltage detecting unit 20 of FIG. 2.

The voltage detecting unit 20 comprises a voltage reducing unit 21 and a power up detecting unit 22.

The voltage reducing unit 21 comprises a plurality of diodes N0˜N2, a NMOS transistor N3 and a buffer BUF.

The plurality of diodes N0˜N2, as PMOS transistors, are connected in series between the power voltage terminal VDD and the NMOS transistor N3, and each of gate and drain terminals is commenly connected thereof performs a role of diode. These diode N0˜N2 drop the power voltage VDD as low as a threshold voltage of N diodes N0˜N2.

The NMOS transistor N3 is selectively turned on according to the reference voltage VREF. Hence, according to the resistance ratio of the plurality of diodes N0˜N2 and the turned-on NMOS transistor N3, the level of supply voltage is changed.

The buffer BUF buffers a supply voltage outputted from a common node of the diode N2 and the NMOS transistor N3.

The power up detecting unit 22 comprises resistors R4 and R5, and inverters IV3 and IV4.

The resistors R4 and R5 are connected in series between an output terminal of the voltage reducing unit 21 and the ground voltage terminal VSS, and divides the supply voltage outputted from the voltage reducing unit 21 according to the resistance ratio to generate a voltage having a predetermined gradient.

The inverter IV3 detects a level of voltage outputted to the common node of the resistors R4 and R5, and generates a predetermined voltage by buffering it when the detected level exceeds a predetermined level. At this time, the predetermined level is a level of threshold voltage of NMOS transistor(not shown) in the inverter IV3.

The inverter IV4 is driven by the power voltage VDD, and output the power up signal PU2 by inverting an output voltage of the inverter IV3.

As shown above, the power up unit 10 and the voltage detecting unit 20 respectively output the power up signals PU1 and PU2, and the NOR gate NOR supplies an output voltage VOUT to an internal circuit by NORing the power up signals PU1 and PU2.

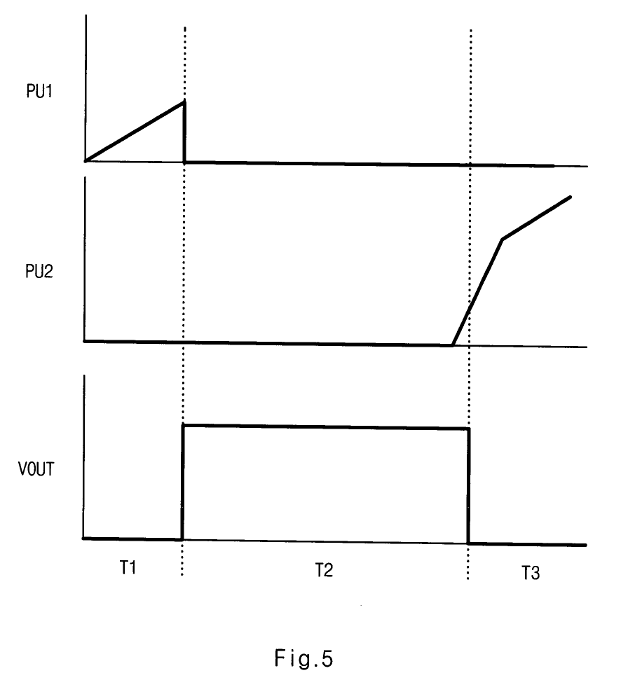

FIG. 5 is a waveform chart illustrating output of each signal of the internal circuit protection device according to the present invention.

First, the power up signal PU1 rises the same gradient as a level of the power voltage VDD, starting from 0V in the region of T1 that is, until the voltage outputted from the voltage dividing unit(11) exceeds the threshold voltage of the inverter IV2.

After that, when the voltage level of the power up signal PU1 exceeds the predetermined threshold voltage of the inverter IV2, the power up signal PU1 transits to a low level in the region of T2.

The power up signal PU2 maintains a low level in the regions of T1 and T2, but it rapidly rises in the region of T3 when the supply voltage outputted from the voltage reducing unit 21 exceeds the input power voltage VDD.

As a result, the output voltage VOUT outputted by NORing the power up signals PU1 and PU2 is enabled to a high level in the region of T2 in which the power up signals PU1 and PU2 are all at a low level. Accordingly, when the output voltage VOUT is at a high level, a level of external power voltage VDD is stably supplied. On the other hand, when the power up signal PU2 for detecting the abnormally inputted power voltage VDD is enabled, the output voltage VOUT transits to a low level, and thereby the operation of internal circuit is ceased.

As a result, the output voltage VOUT maintains a high level just in the operating region of chip, thereby protecting the internal circuit from abnormal change in a power voltage.

As mentioned above, since the present invention applies to circuits for low voltage or all circuits in which the power supply is unsteadily inputted, the present invention can prevent the internal circuit from wrongly operating when the external power supply is abnormally increased and prolong the lifetime of chip.

While the invention is susceptible to various modifications and alternative forms, specific embodiments have been shown by way of example in the drawings and described in detail herein. However, it should be understood that the invention is not limited to the particular forms disclosed. Rather, the invention covers all modifications, equivalents, and alternatives falling within the spirit and scope of the invention as defined in the appended claims.

1. An internal circuit protection device, comprising:
a power up unit for detecting a level of a power voltage, and generating a first power up signal when the detected level exceeds a first level;
a voltage detecting unit for detecting the level of the power voltage, and generating a second power up signal when the detected level exceeds a second level higher than the first level; and
an output unit for combining the first and second power up signals, and generating a control signal which is enabled in a predetermined region of the power voltage level.

2. The internal circuit protection device according to claim 1, wherein the predetermined region of the output unit ranges from a moment that the first power up signal is enabled to a moment that the second power up signal is enabled.

3. The internal circuit protection device according to claim 1, wherein the power up unit comprises a voltage dividing unit for dividing a level of the power voltage according to preset resistance ratio; and a driving unit for outputting the first power up signal by buffering output of the voltage dividing unit according to the level of the power voltage.

4. The internal circuit protection device according to claim 3, wherein the voltage dividing unit comprises a plurality of resistors connected in series.

5. The internal circuit protection device according to claim 3, wherein the driving unit is an inverter which is driven when the output of the voltage dividing unit exceeds a predetermined level.

6. The internal circuit protection device according to claim 5, the predetermined level of the driving unit is a threshold voltage of a NMOS transistor in the inverter.

7. The internal circuit protection device according to claim 1, wherein the voltage detecting unit comprises a voltage reducing unit for outputting a supply voltage by dropping a level of the power voltage; and a power up detecting unit for generating a predetermined voltage by dividing the supply voltage, detecting a level of the predetermined voltage and outputting the second power up signal by driving the detected predetermined voltage according to the level of the power voltage.

8. The internal circuit protection device according to claim 7, wherein the voltage reducing unit comprises a plurality of diodes connected in series.

9. The internal circuit protection device according to claim 7, wherein the voltage reducing unit comprises a plurality of resistors for dividing and outputting the power voltage according to the resistance ratio.

10. The internal circuit protection device according to claim 7, wherein the power up detecting unit comprises a resistance dividing unit for dividing the supply voltage; a first driving unit for driving the output of the resistor dividing unit according to the supply voltage; and a second driving unit for outputting the second power up signal by driving the output of the first driving unit according to the power voltage level.

11. The internal circuit protection device according to claim 1, wherein the output unit is a NOR gate.
